(19) United States
(12) Patent Application Publication
(10) Pub. No.: US 2021/0052116 A1
(43) Pub. Date: Feb. 25, 2021

(54) Waterless Sewage Device And Waterless Toilet

(71) Applicant: Paul Chuang, Tainan City (TW)

(72) Inventor: Paul Chuang, Tainan City (TW)

(21) Appl. No.: 16/549,797

(22) Filed: Aug. 23, 2019

(51) Int. Cl. A47K 11/02; A47K 11/06

(52) U.S. Cl. CPC A47K 11/02; A47K 11/06

(57) ABSTRACT

A waterless sewage device and a waterless toilet comprise: a framework having a ring at the top; and a strip bag body having a bottom, a strip bag wall and an opening; wherein the opening of the strip bag body is turned downward outside the ring; thence the strip bag wall is completely folded up surrounding the framework; thereby excreta is collected without using water.

### FIELD OF THE INVENTION

The present invention relates to a waterless sewage device and a waterless toilet; particularly to a waterless sewage device and a waterless toilet which is used for processing human excreta.

### BACKGROUND OF THE INVENTION

Nowadays most toilet needs a lot of water, not only for isolating excreta stink, but also for easy cleaning.

However, for such toilet a large quantity of water is required, it is difficult to be applied to such places, like temporary structure, where water cannot be sufficiently supplied. Furthermore, by public transportation like bus, airplane, water supply of large quantity may cause lots charge.

In view of these disadvantages the inventor tried the continuous testing and improvement and developed the present invent

### SUMMARY OF THE INVENTION

The main object of the present invention is to provide a waterless sewage device for collecting excreta, wherein no water is used.

For achieving above object, the present invention comprises: a framework having a ring at the top; and a strip bag body having a bottom, a strip bag wall and an opening; wherein the opening of the strip bag body is turned downward outside of the ring, by that the strip bag wall is kept surrounding the frame;

Preferably, at the bottom of the framework there are a front bracket and a rear bracket, both connected to a roller device comprising: a first module having a first rotating shaft and a first roll wheel, wherein the first rotating shaft is set pivoted between the front bracket and the rear bracket; a second module having a second rotating shaft and a second roll wheel, wherein the second rotating shaft is set pivoted between the front bracket and the rear bracket; a drive unit connected to the first rotating shaft for rotating the first rotating shaft, and for driving the first roll wheel to scroll toward the second roll wheel; and a transmission unit, connected to the first rotating shaft and the second rotating shaft, whenever the first rotating shaft rotates, the first roll wheel and the second roll wheel are driven thereby to scroll in opposite direction; thereby, it is convenient to close the used part of the strip bag body.

Preferably, the drive unit is an electric motor, thereby manpower is saved.

Preferably, the transmission unit comprises: a first gear set on the first rotating shaft; and a second gear set on the second rotating shaft and meshed with the first gear; thereby, whenever the first rotating shaft rotates, the first roll wheel and the second roll wheel are driven to scroll in opposite direction.

Preferably, at least one of the first roll wheel and the second roll wheel has an elastic layer; as the second roll wheel and the first roll wheel are closed together, thereby, there is a tight fit between the first roll wheel and the second roll wheel.

Preferably, at least one of the first roll wheel and the second roll wheel has a hollowing part; thereby, there is a tight fit between the first roll wheel and the second roll wheel.

Preferably, the strip bag body is made of biodegradable materials; thereby it is convenient for disposal.

Preferably, bellow the first roll wheel and the second roll wheel there is a storage bucket which is used for temporary keeping the strip bag body.

Another object of the present invention is to provide a waterless toilet, wherein excreta are collected without using water.

For achieving above object, the present invention comprises: a toilet main body set on the ground; a toilet seat cushion with a excretion hole, set at the toilet main body; and the waterless sewage device, as mentioned above, set beneath the toilet seat cushion.

Other aspects and advantages of the present invention will become apparent from the following detailed description, taken in conjunction with the accompanying drawing, illustrating by way of example the principles of the present invention.

### BRIEF DESCRIPTION OF THE DRAWING

FIG. 1 is a three-dimensional view of a waterless sewage device of the present invention.

FIG. 2 is a schematic view of a strip bag body of the present invention before it is folded.

FIG. 3 is an exploded view of the waterless sewage device of the present invention.

FIG. 4 is a three-dimensional view of a roll wheel device at the bottom of a framework of the present invention.

FIG. 5 is a side view of a roll wheel device at the bottom of a framework of the present invention.

FIG. 6 is a schematic view of the roll wheel device of the present invention closing a used part of the strip bag body.

FIG. 7 is a schematic view of a first roll wheel having an elastic layer of the present invention.

FIG. 8 is a schematic view of both the first roll wheel and the second roll wheel having an elastic layer.

FIG. 9 is a schematic view of a second roll wheel of the present invention having a hollowing part.

FIG. 10 is a sectional view of the first roll wheel and the second roll wheel of the present invention.

FIG. 11 is a schematic view of a drive unit of the present invention connected to a programmable logic controller.

FIG. 12-16 are schematic views of continuous motion of the first roll wheel and the second roll wheel of the present invention scrolling in opposite directions to drive the strip bag body.

FIG. 17 is a schematic view of both the first roll wheel and the second roll wheel of the present invention having a hollowing part.

FIG. 18 is a schematic view of a storage bucket beneath the framework of the present invention.

FIG. 19 is a three-dimensional view of a waterless toilet of the present invention.

### DESCRIPTION OF THE PREFERRED EMBODIMENTS

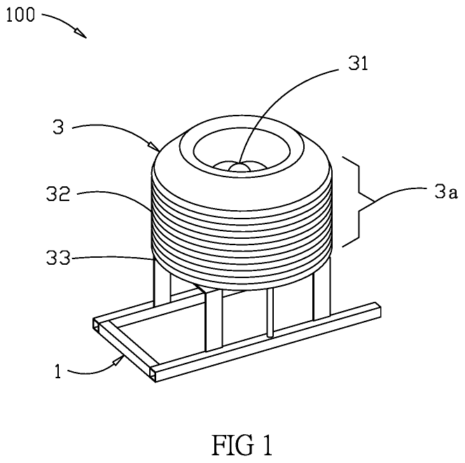

As shown in FIG. 1-3, the waterless sewage device 100 of the present invention comprises: a framework 1, wherein there is a ring 2 at the top; a strip bag body 3 having a bottom 31, a strip bag wall 32 and an opening 33, wherein the bottom 31 of the strip bag body 3 is set within the ring, wherein the opening 33 of the strip bag body 3 is turned downward outside of the ring, thence the strip bag wall 32 is folded up kept surrounding the framework 1; thereby, excreta are collected without using water. The details will be explained below.

The framework 1 is any available construction, which is principally used to support the ring 2 and the strip bag body 3.

The ring 2 is used for keeping the bag body 3 unfolded.

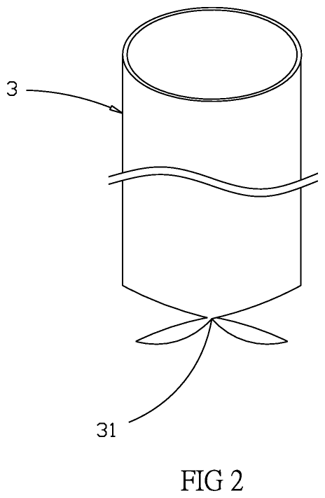

The strip bag body 3 is formed as a tube, wherein the bottom 31 can be closed by tying a knot (as shown in FIG. 2), hot melting (not shown), clamping (not shown) or other ways (not shown), for collecting excreta.

Since the strip bag body 3 is made of foldable flexible body, when the bottom 31 is set within the ring 2, most part of the destined part 3a is foldable kept surrounding the framework 1; thereby it is possible for frequent using. The inside diameter D1 of the strip bag body 3 is larger than the outside diameter D2 of the ring 2, thereby it is convenient for the destined part 3a to turn outward to outside of the ring. Besides, as the bottom of the strip bag body 3 and the strip bag wall 32 are set within the ring 2, each part of the strip bag wall 32 can fold each other, whereby the total inside diameter of the strip bag body 3 is reduced; however, for clear explanation, the folding texture of foldable parts, by which the total inside diameter of the strip bag wall 32 is reduced, is omitted in the drawings.

The strip bag body 3 is principally used for collecting excreta, since it is long enough, whenever it is used, preliminary cleaning is quickly achieved by closing the bottom, thereby it is convenient for the next use. Besides, the strip bag body 3 is made of biodegradable materials, hence it is convenient for the follow-up processing. Compared to conventional bedpan and toilet seat, the strip bag body 3 has at least these advantages: quick cleaning and no requirement for wash.

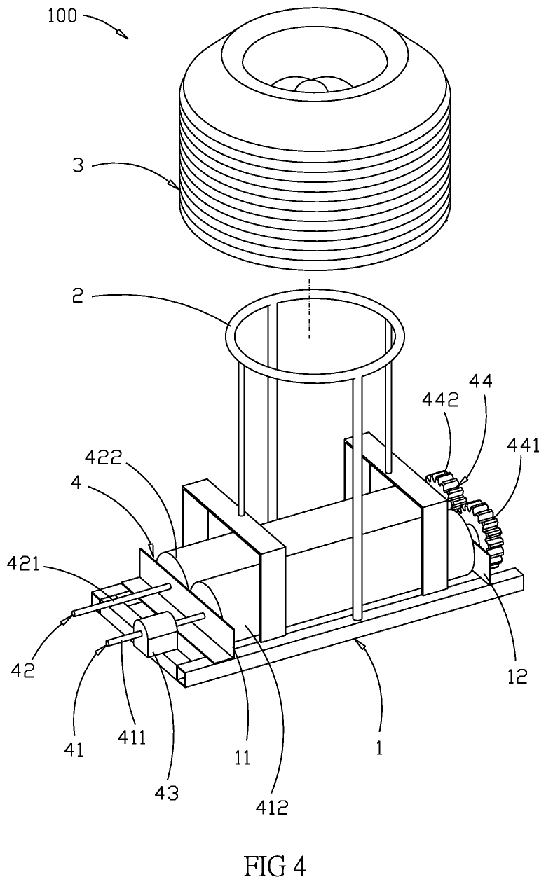

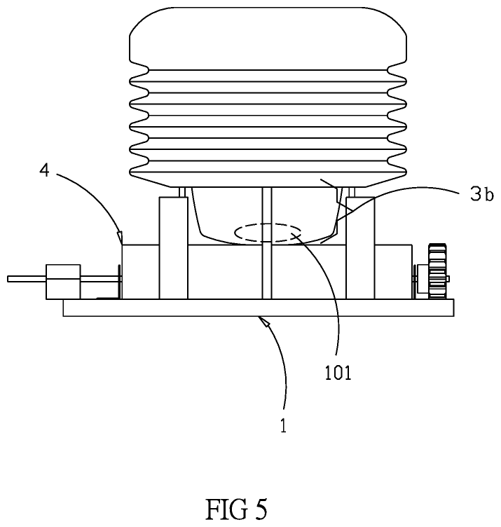

As shown in FIG. 4-6, the composition of the framework 1, the ring 2 and the strip bag body 3 is principally used for collecting excreta without using water. However, usually excreta make stink. To solve this problem, at the bottom of the framework 1 is further set e.g. a roll wheel device 4, a valve device (not shown) or any other device (not shown) which can sectionally close a dirty used part 3b of the strip bag body 3, thereby diffusion from excreta is avoided.

At the bottom of the framework 1 there is a front bracket 11 and a rear bracket 12, connected to a roll wheel device 4, wherein the roll wheel device 4 comprises: a first module 41 having a first rotating shaft 411 and a first roll wheel 412, wherein the first rotating shaft 411 is pivoted set between the front bracket 11 and the rear bracket 12; a second module 42 having a second rotating shaft 421 and a second roll wheel 422, wherein the second rotating shaft 421 is pivoted set between the front bracket 11 and the rear bracket 12; a drive unit 43, connected to the first rotating shaft 411 for rotating the first rotating shaft and driving the first roll wheel 412 toward the second roll wheel 422 to scroll; and a transmission unit 44, connected to the first rotating shaft 411 and the second rotating shaft 421, for driving the first roll wheel 412 and the second roll wheel 422 in opposite direction to scroll, whenever the first rotating shaft 411 rotates. The roll wheel device is used for sectional closing part of the strip bag body 3, particularly for the used part 3b which has contacted dirt.

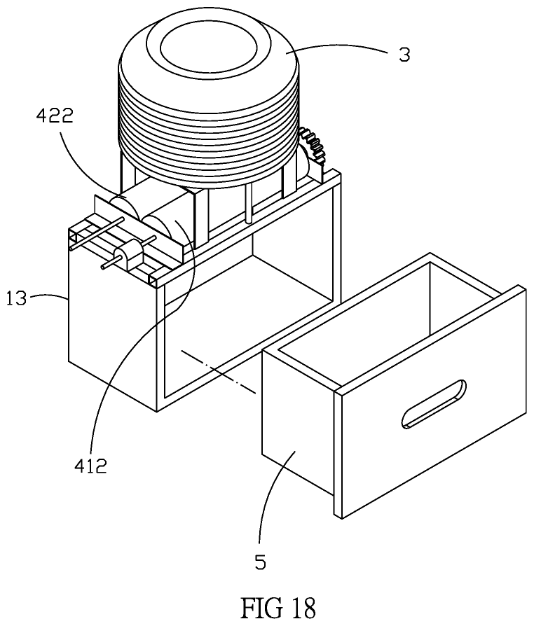

The framework 1 can be set for every suitable places, e.g. somewhere there is a groove bellow (not shown), or where there is a stand 13 under the framework 1 (as shown in FIG. 18), or where is set with a plurality of brackets under a toilet seat (not shown).

The drive unit 43 connected to the first rotating shaft 411 for rotating the first rotating shaft 411, and driving the first roll wheel 412 toward the second roll wheel 422 to scroll, wherein an electric motor is used for saving manpower, or manual operation, foot pedal is used as power (not shown).

The transmission unit 44 connected to the first rotating shaft 411 and the second rotating shaft 421, whenever the first rotating shaft 411 rotates, the first roll wheel 412 and the second roll wheel 422 are driven in opposite direction to scroll; wherein the usual transmission device, e.g. gear, belt (not shown) is used. Here is an example described as bellow. The transmission unit 44 comprises: a first gear 441, set on the first rotating shaft 411; and a second gear 442, set on the second rotating shaft 421, meshed with the first gear 441.

While the used part 3b of the strip bad body 3 filled with excreta passing through the first roll wheel 412 and the second roll wheel 422, the excreted mud is pressed and deformed; however, for clear explanation in all the drawings there is an oval in the same shape to signify a excreted mud.

As shown in FIG. 4-6, whenever excreted mud 101 is set within the strip bag body 3, the first rotating shaft 411 rotates, thereby the first roll wheel 412 and the second roll wheel 422 are driven to scroll, furthermore, the used part 3b of the strip bag body 3 together with the excreted mud 101 is brought beneath the first roll wheel 412 and the second roll wheel 422. Besides, the used part 3b of the strip bag body 3 is closed by the first roll wheel 412 and the second roll wheel 422, thereby diffusion from the excreta is avoided.

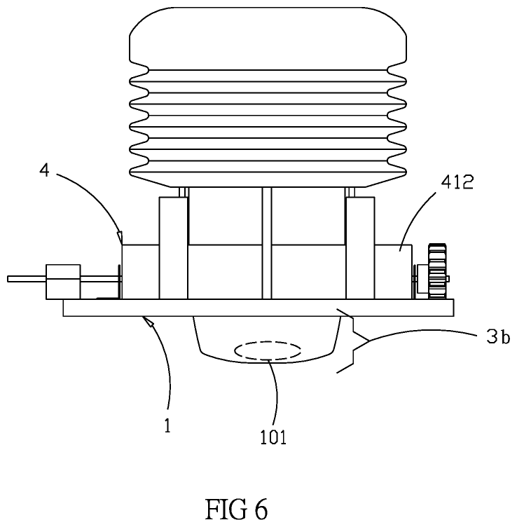

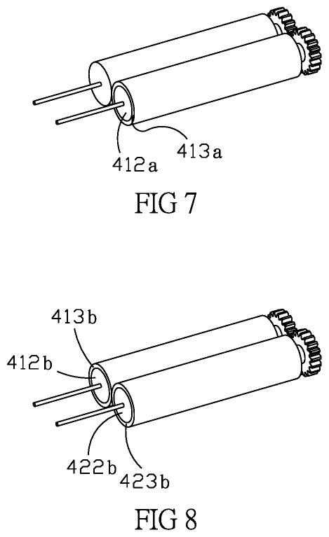

As shown in FIG. 7-8, either one of the first roll wheel and the second roll wheel has an elastic layer on the surface, or both the first roll wheel and the second roll wheel have an elastic layer on the surface separately; here the first roll wheel with an elastic layer is described as an example. As shown in FIG. 7, the first roll wheel 412a has an elastic layer 413a on the surface, thereby the first roll wheel and the second roll wheel are closed with a tight fit, while excreted mud is passing through the first roll wheel and the second roll wheel therebetween, the elastic layer 413a is served as a buffer; even the excreted mud has passed through, the first roll wheel and the second roll wheel are closed tightly together as before, thereby the used part of the strip bag body is exactly closed. As shown in FIG. 8, when both the first roll wheel 412b and the second roll wheel 422b are set with elastic layers 413b and 423b separately, the allowed amount of excreted mud passing through the first roll wheel 412b and the second roll wheel 422b is increased, compared to that, only the first roll wheel has an elastic layer (as shown in FIG. 7), or only the second roll wheel has an elastic layer (not shown).

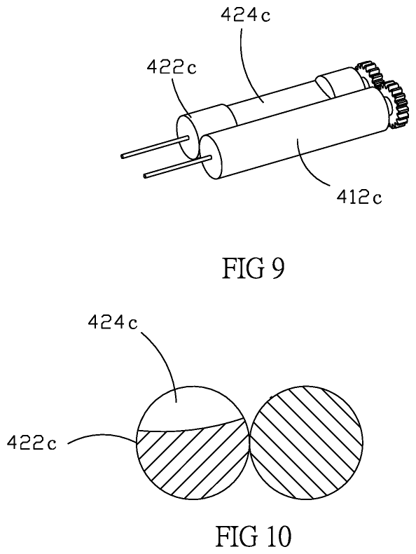

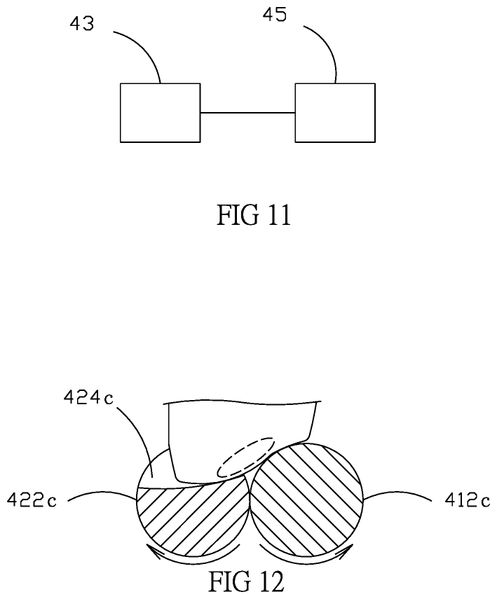

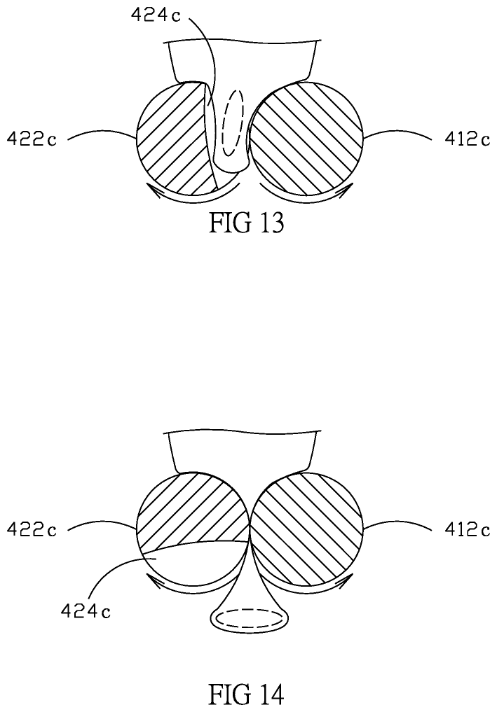

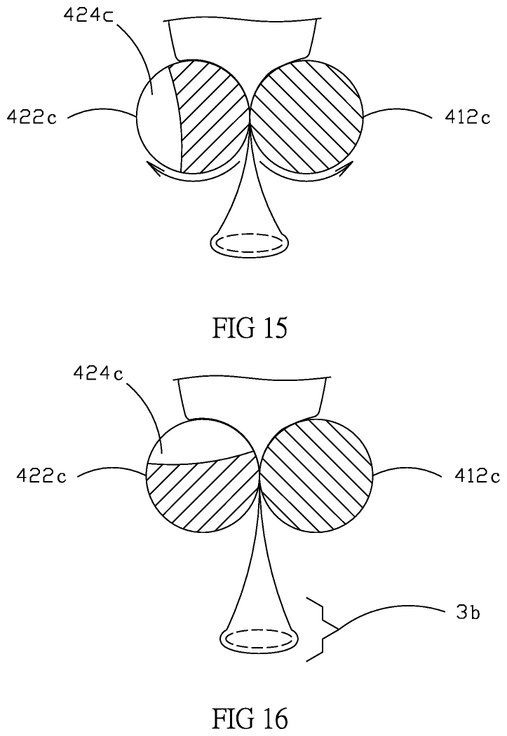

As shown in FIG. 9-17, either one of the first roll wheel and the second roll wheel has a hollowing part, or both the first roll wheel and the second roll wheel have a hollowing part separately; here is the second roll wheel described as explanation as bellow. As shown in FIG. 9, the second roll wheel 422c has a hollowing part 424c, thereby it is convenient for excreted mud to pass through the first roll wheel 412c and the second roll wheel 422c; furthermore, between the first roll wheel 412c and the second roll wheel 422c there is no gap for excreta to pass through, but it is tightly closed therebetween; when the first roll wheel 412c and the second roll wheel are driven to bring excreta passing through therebetween, the excreted mud is keeping in the hollowing part 424c; after the excreted mud has passed through, the first roll wheel 412c and the second roll wheel 422c are tightly closed as before; thereby the used part of the strip bag body is exactly closed.

As shown in FIG. 10-16, as the second roll wheel 422c has the hollowing part 424c, the drive unit 43 is controlled by a programmable logic controller; thereby rotation of the second roll wheel 422c is controlled by one circle by each rotation, thence the first roll wheel 412c and the second roll wheel 422c are in a constant state of being closed together (as shown in FIG. 16), thereby the used part 3b of the strip bag body is exactly closed.

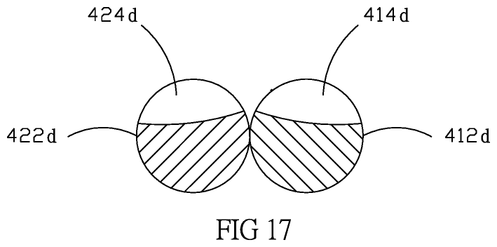

As shown in FIG. 17, when both the first roll wheel 412d and the second roll wheel 422d have hollowing parts 414d, 424d separately, the allowed amount of excreted mud passing through the first roll wheel 412d and the second roll wheel 422d is increased, compared to that, when only the first roll wheel has a hollowing part (not shown) or only the second roll wheel has a hollowing part (as shown in FIG. 10).

As shown in FIG. 18, beneath the first roll wheel 412 and the second roll wheel 422 there is a storage bucket 5 for temporary keeping the strip bag body 3.

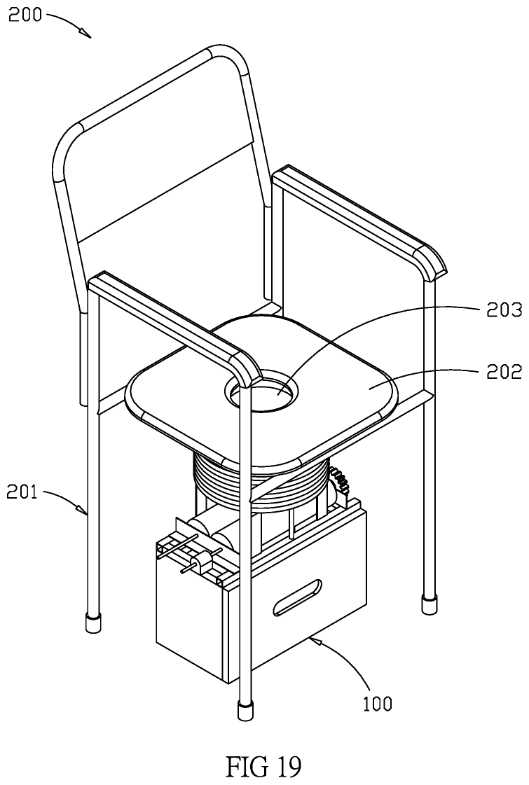

As shown in FIG. 19, furthermore, the present invention provides a waterless toilet 200, comprising: a toilet main body 201 set on the ground; a toilet seat cushion 202 set on the toilet main body 201, having excretion hole 203; and a waterless sewage device 100 set under the toilet seat cushion 202; thereby, it is achieved to collect excreta without using water.

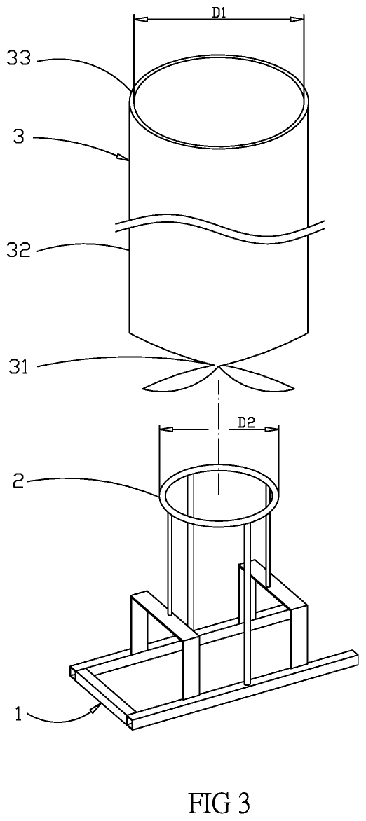

As shown in FIG. 3 and FIG. 19, the ring 2 of the waterless sewage device 100 is aligned to the excretion hole 203 of the toilet seat cushion 202, thereby it is convenient to collect excreta. Besides, the ring 2 is larger than the excretion hole 203 of the toilet seat cushion 202 and possibly near beneath the toilet seat cushion 202, thereby it is convenient to collect all excreta passing thorough the excretion hole exactly.

The toilet main body 201 is a framework built by a plurality of brackets, it can also be a one-piece structure, e.g. made of ceramic material (not shown).

While preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A waterless sewage device, comprises:
a framework, having a ring at the top; and
a strip bag body, having a bottom, a strip bag wall and an opening;
wherein the opening of the said strip bag body is turned downward beneath the ring, thereby the strip bag wall is foldable, kept surrounding the framework.

2. The waterless sewage device of the claim 1, comprises:
at the bottom of the said framework there are a front bracket and a rear bracket;
between the said front bracket and the rear bracket there is a roll wheel device connected therebetween, the said roll wheel device comprises:
a first module, having a first rotating shaft and a first roll wheel; wherein the first roll rotating shaft is pivoted between the front bracket and the rear bracket;
a second module, having a second rotating shaft and a second roll wheel; wherein the second rotating shaft is pivoted between the front bracket and the rear bracket;
a drive unit, connected to the first rotating shaft for rotating the said first rotating shaft, and driving the first roll wheel toward the second roll wheel to scroll; and
a transmission unit, connected to the first rotating shaft and the second rotating shaft, whenever the first rotating shaft rotates, the first roll wheel and the second roll wheel are driven to scroll in opposite direction.

3. The waterless sewage device of the claim 2, wherein the said drive unit is an electric motor.

4. The waterless sewage device of the claim 2, wherein the said transmission unit comprises:
A first gear, set on the first rotating shaft;
A second gear, set on the second rotating shaft, meshed with the first gear.

5. The waterless sewage device of the claim 2, wherein at least one of the said first roll wheel and the said second roll wheel has an elastic layer, wherein the first roll wheel and the second roll wheel are closed together.

6. The waterless sewage device of the claim 2, wherein at least one of the said first roll wheel and the said second roll wheel has a hollowing part.

7. The waterless sewage device of the claim 1, wherein the said strip bag body is made of biodegradable materials.

8. The waterless sewage device of the claim 1, wherein there is a storage bucket beneath the said first roll wheel and the said second roll wheel.

9. A waterless toilet, comprises:
a toilet main body, set on the ground;
a toilet seat cushion, set on the toilet main body, having a excretion hole; and
a waterless sewage device, set beneath the said toilet seat cushion, the said waterless sewage device comprises:
a framework, having a ring at the top; and
a strip bag body, having a bottom, a strip bag wall and an opening;
wherein the opening of the said strip bag body is turned downward beneath the ring, thereby the strip bag wall is foldable, kept surrounding the framework.

10. The waterless sewage device of the claim 9, comprises:
at the bottom of the said framework there are a front bracket and a rear bracket; between the said front bracket and the rear bracket there is a roll wheel device connected therebetween, the said roll wheel device comprises:
a first module, having a first rotating shaft and a first roll wheel; wherein the first roll rotating shaft is pivoted between the front bracket and the rear bracket;
a second module, having a second rotating shaft and a second roll wheel; wherein the second rotating shaft is pivoted between the front bracket and the rear bracket;
a drive unit, connected to the first rotating shaft for rotating the said first rotating shaft, and driving the first roll wheel toward the second roll wheel to scroll; and
a transmission unit, connected to the first rotating shaft and the second rotating shaft, whenever the first rotating shaft rotates, the first roll wheel and the second roll wheel are driven to scroll in opposite direction.

11. The waterless sewage device of the claim 10, wherein the said drive unit is an electric motor.

12. The waterless sewage device of the claim 10, wherein the said transmission unit comprises:
A first gear, set on the first rotating shaft;
A second gear, set on the second rotating shaft, meshed with the first gear.

13. The waterless sewage device of the claim 10, wherein at least one of the said first roll wheel and the said second roll wheel has an elastic layer, wherein the first roll wheel and the second roll wheel are closed together.

14. The waterless sewage device of the claim 10, wherein at least one of the said first roll wheel and the said second roll wheel has a hollowing part.

15. The waterless sewage device of the claim 9, wherein the said strip bag body is made of biodegradable materials.

16. The waterless sewage device of the claim 9, wherein there is a storage bucket beneath the said first roll wheel and the said second roll wheel.
